(19) United States
(12) Patent Application Publication
(10) Pub. No.: US 2025/0156184 A1
(43) Pub. Date: May 15, 2025

(54) SUB-VECTOR-SUPPORTING INSTRUCTION FOR SCALABLE VECTOR INSTRUCTION SET ARCHITECTURE

(71) Applicant: Arm Limited, Cambridge (GB)

(72) Inventors: Alejandro Martinez Vicente, Cambridge (GB); Peng Sun, Cambridge (GB)

(73) Assignee: Arm Limited, Cambridge (GB)

(21) Appl. No.: 18/844,296

(22) PCT Filed: Dec. 15, 2022
(86) PCT No.: PCT/GB2022/053244

§ 371 Date: Sep. 5, 2024

(30) Foreign Application Priority Data
Mar. 11, 2022 (GB) 2203431.8

(51) Int. Cl. G06F 9/30

(52) U.S. Cl. CPC G06F 9/3016; G06F 9/30036

(57) ABSTRACT

An apparatus has processing circuitry (16) to perform data processing, and instruction decoding circuitry (10) to control the processing circuitry to perform the data processing in response to decoding of program instructions defined according to a scalable vector instruction set architecture supporting vector instructions operating on vectors of scalable vector length to enable the same instruction sequence to be executed on apparatuses with hardware supporting different maximum vector lengths. The instruction decoding circuitry and the processing circuitry support a sub-vector-supporting instruction which treats a given vector as comprising a plurality of sub-vectors with each sub-vector comprising a plurality of vector elements. In response to the sub-vector-supporting instruction, the instruction decoding circuitry controls the processing circuitry to perform an operation for the given vector at sub-vector granularity. Each sub-vector has an equal sub-vector length.

The present technique relates to the field of data processing.

An instruction set architecture (ISA) defines the set of instructions available to a software developer or compiler when developing a particular software program, and in a corresponding way defines the set of instructions which need to be supported by a processor implementation in hardware to allow the hardware to be compatible with software written according to the ISA. For example, the ISA may define, for each instruction, the encoding of the instruction, a representation of its input operands and result value, and the functions for mapping the input operands to the result of the instruction.

A vector ISA supports at least one vector instruction which operates on a vector operand comprising two or more independent vector elements represented within a single register, and/or generates a vector result comprising two or more independent vector elements. The vector instruction can be processed in a SIMD (single instruction, multiple data) fashion to allow multiple independent calculations to be performed on different data values in response to a single instruction. Vector instructions can be useful, for example, to allow a scalar loop of instructions written in high level code to be vectorised so that processing corresponding to multiple loop iterations can be performed in response to a single iteration of vectorised loop. This helps to improve performance by reducing the number of instructions which need to be fetched, decoded and executed to carry out a certain amount of data processing.

At least some examples provide an apparatus comprising: processing circuitry to perform data processing; and instruction decoding circuitry to control the processing circuitry to perform the data processing in response to decoding of program instructions defined according to a scalable vector instruction set architecture supporting vector instructions operating on vectors of scalable vector length to enable the same instruction sequence to be executed on apparatuses with hardware supporting different maximum vector lengths; in which: the instruction decoding circuitry and the processing circuitry are configured to support a sub-vector-supporting instruction which treats a given vector as comprising a plurality of sub-vectors with each sub-vector comprising a plurality of vector elements, each sub-vector having an equal sub-vector length; and in response to the sub-vector-supporting instruction, the instruction decoding circuitry is configured to control the processing circuitry to perform an operation for the given vector at sub-vector granularity.

At least some examples provide a method comprising: decoding, using instruction decoding circuitry, program instructions defined according to a scalable vector instruction set architecture supporting vector instructions operating on vectors of scalable vector length to enable the same instruction sequence to be executed on apparatuses with hardware supporting different maximum vector lengths; and controlling processing circuitry to perform data processing in response to decoding of the program instructions; in which: the instruction decoding circuitry and the processing circuitry support a sub-vector-supporting instruction which treats a given vector as comprising a plurality of sub-vectors with each sub-vector comprising a plurality of vector elements, each sub-vector having an equal sub-vector length; and in response to the sub-vector-supporting instruction, the instruction decoding circuitry controls the processing circuitry to perform an operation for the given vector at sub-vector granularity.

At least some examples provide a computer program to control a host data processing apparatus to provide an instruction execution environment for execution of target code; the computer program comprising: instruction decoding program logic to decode instructions of the target code to control the host data processing apparatus to perform data processing in response to the instructions of the target code; in which: the instruction decoding program logic supports decoding of program instructions defined according to a scalable vector instruction set architecture supporting vector instructions operating on vectors of scalable vector length to enable the same instruction sequence to be executed on apparatuses with hardware supporting different maximum vector lengths; the instruction decoding program logic comprises sub-vector-supporting instruction decoding program logic to decode a sub-vector-supporting instruction which treats a given vector as comprising a plurality of sub-vectors with each sub-vector comprising a plurality of vector elements, each sub-vector having an equal sub-vector length; and in response to the sub-vector-supporting instruction, the instruction decoding program logic is configured to control the host data processing apparatus to perform an operation for the given vector at sub-vector granularity.

The computer program may be stored on a storage medium. The storage medium may be a non-transitory storage medium.

Further aspects, features and advantages of the present technique will be apparent from the following description of examples, which is to be read in conjunction with the accompanying drawings, in which:

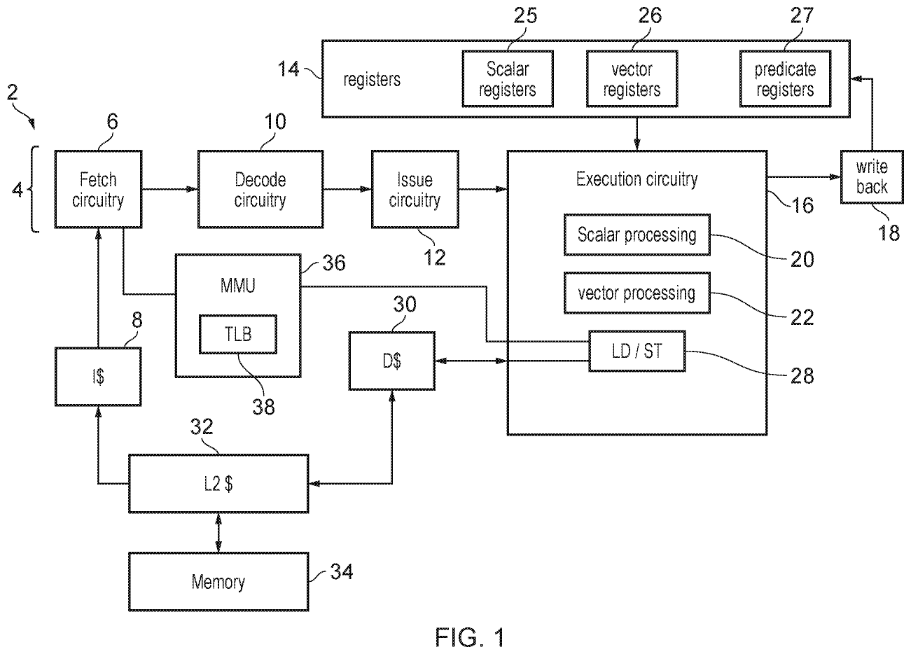

FIG. 1 illustrates an example of a data processing apparatus supporting a vector ISA;

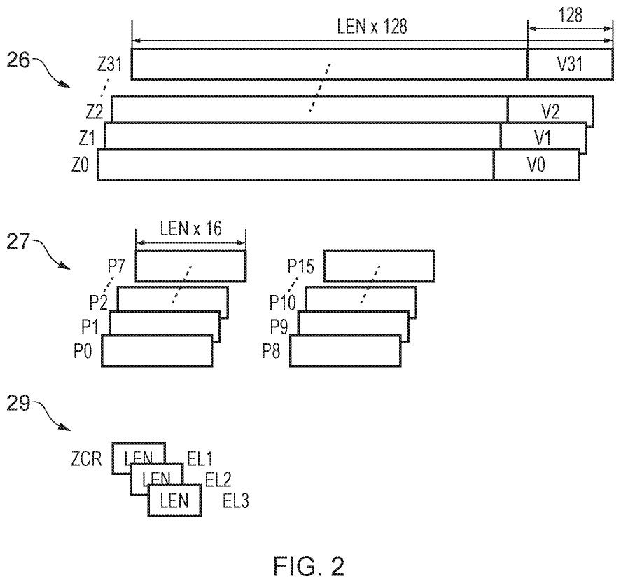

FIG. 2 shows an example of registers for a scalable vector ISA;

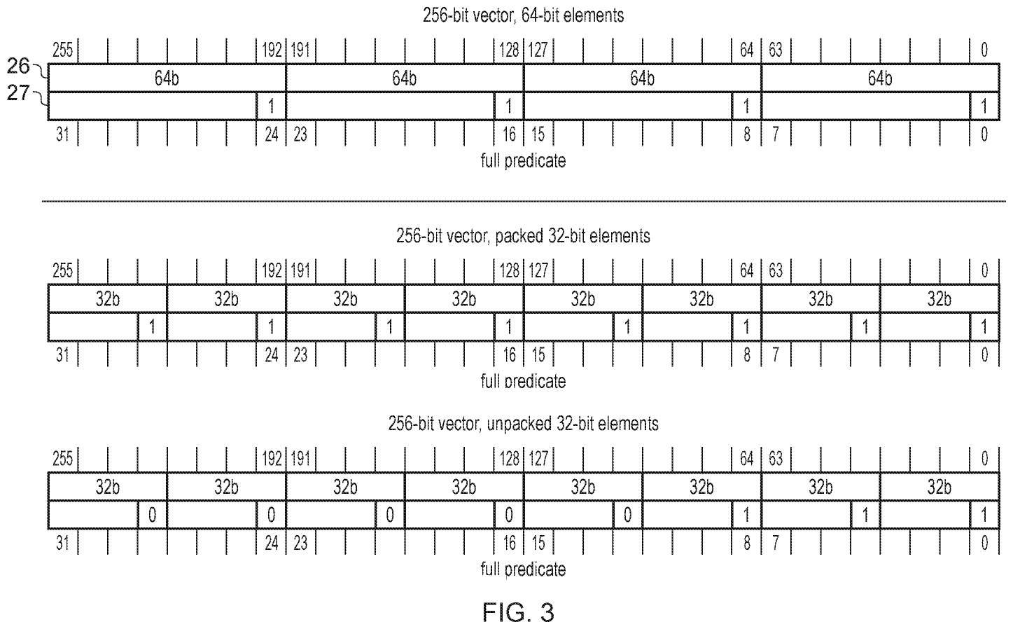

FIG. 3 shows an example of predication and variable vector element size;

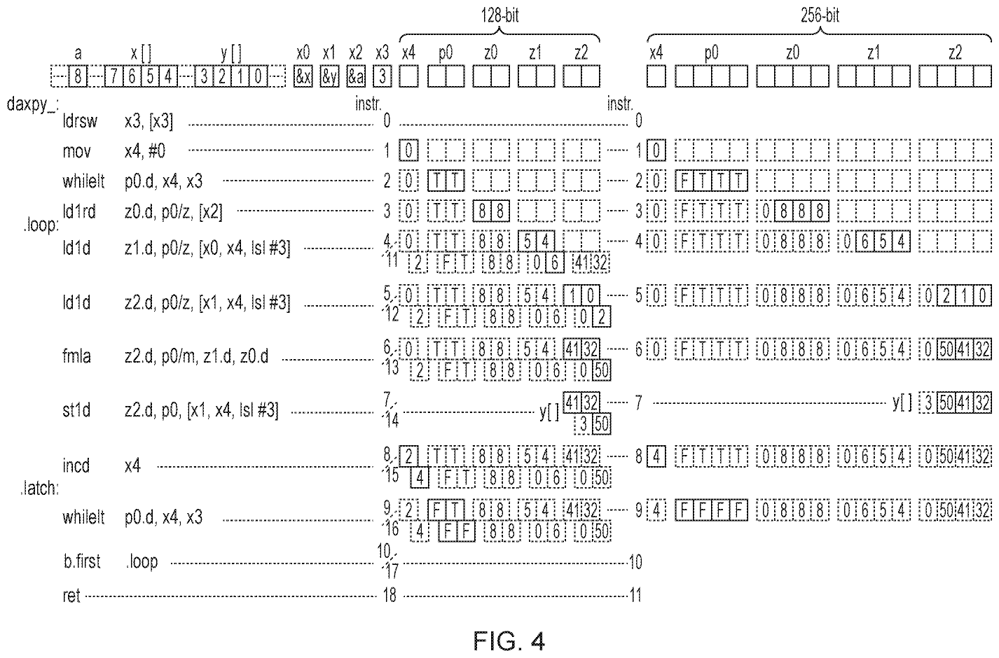

FIG. 4 illustrates an example of the scalable vector ISA enabling different hardware implementations supporting different maximum vector length to execute the same instruction sequence;

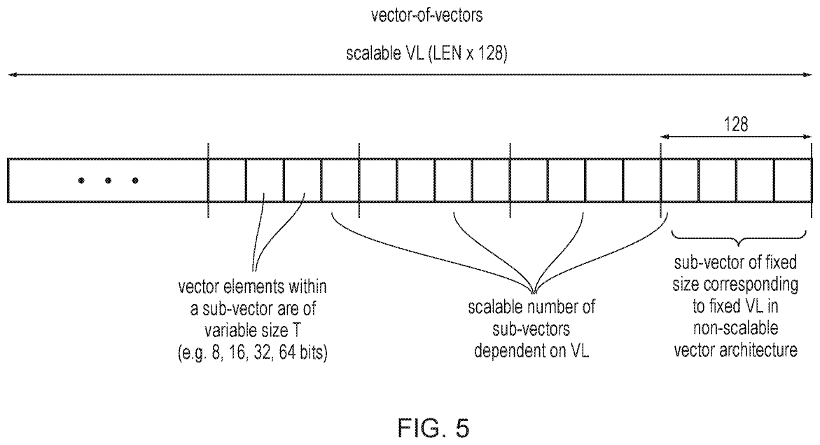

FIG. 5 shows an example of a vector treated as a vector of sub-vectors;

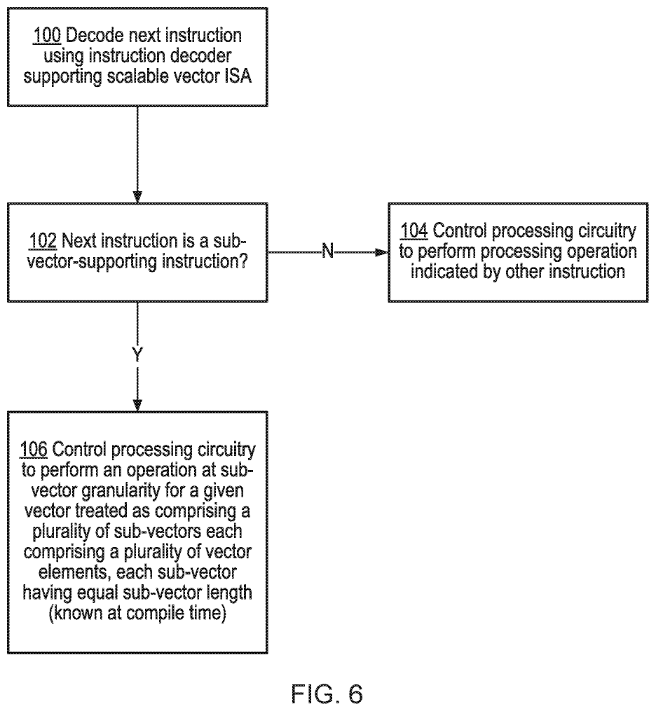

FIG. 6 shows a method of processing a sub-vector-supporting instruction;

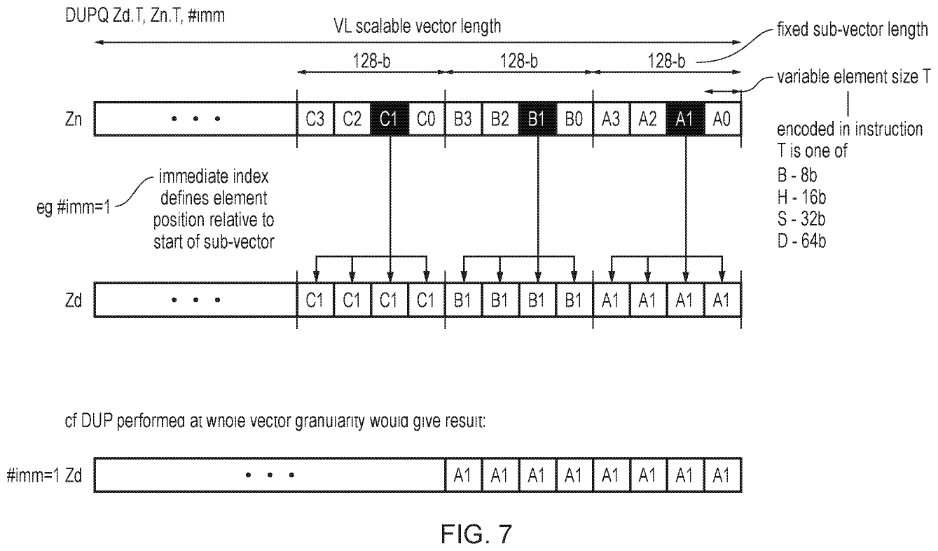

FIGS. 7 to 11 illustrate several examples of sub-vector-supporting permute instructions;

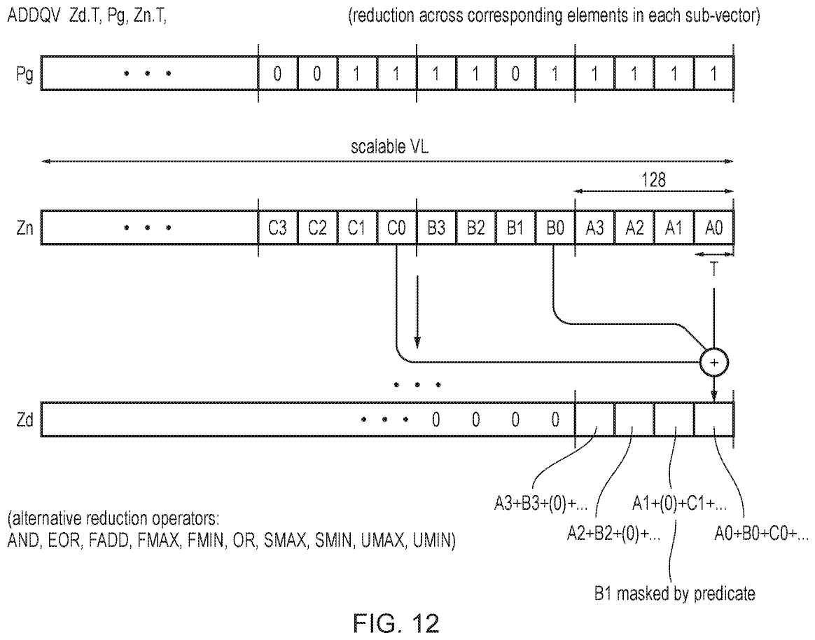

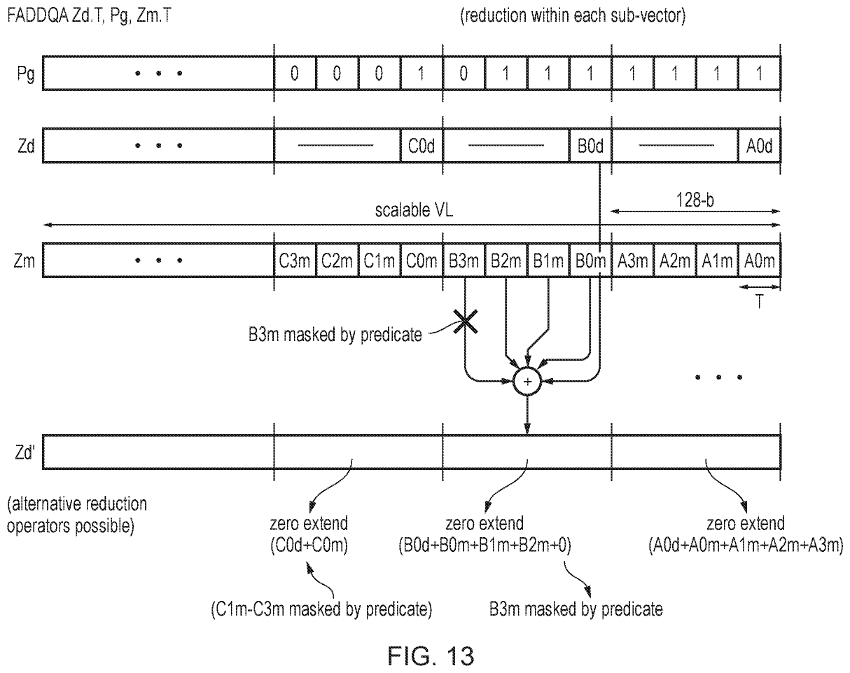

FIGS. 12 and 13 illustrate examples of sub-vector-supporting reduction instructions;

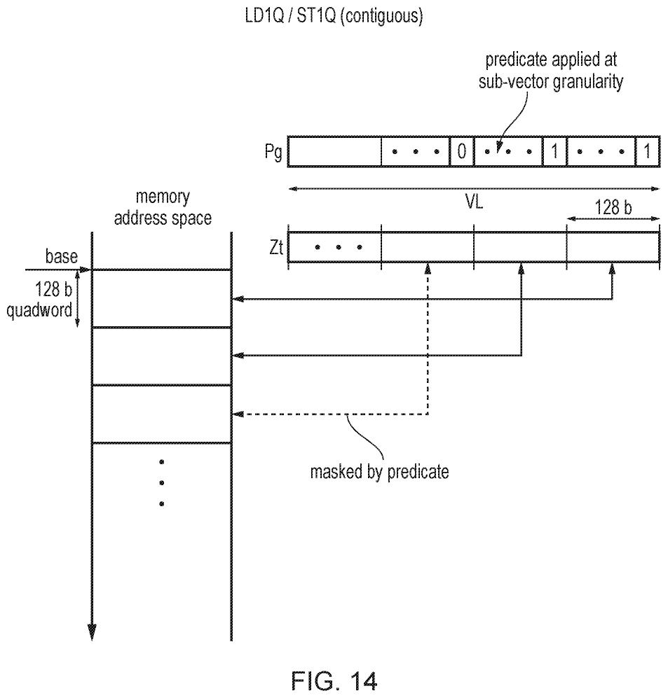

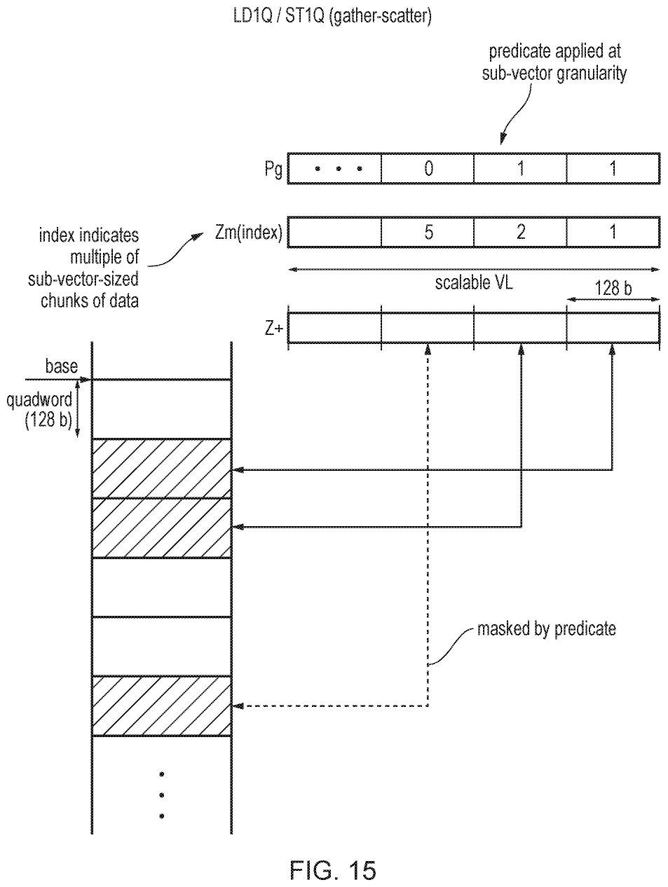

FIGS. 14 and 15 illustrate examples of sub-vector-supporting load/store instructions;

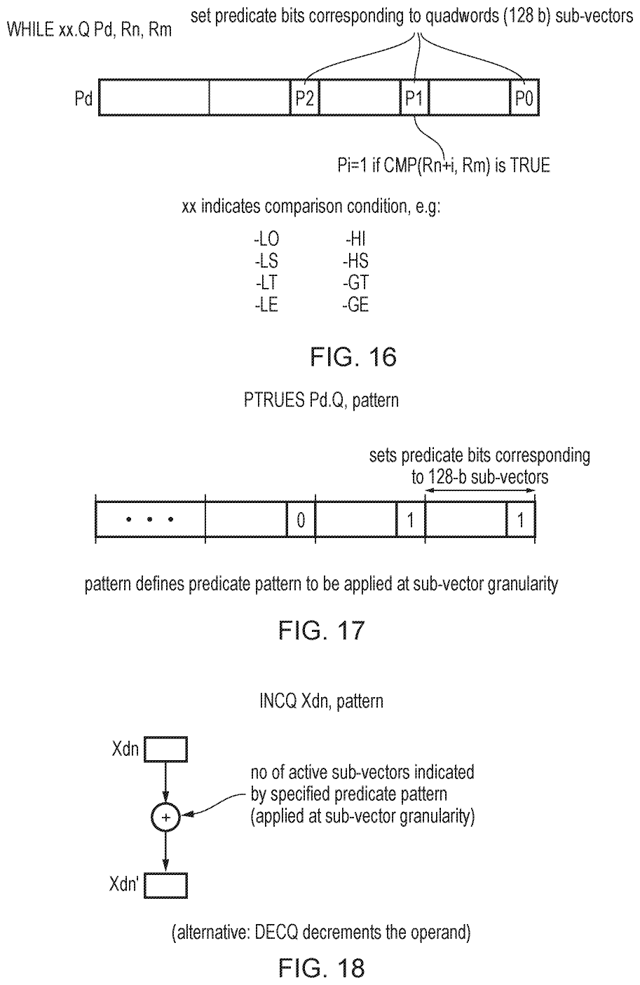

FIGS. 16 and 17 illustrate examples of sub-vector-supporting predicate-setting instructions;

FIG. 18 illustrates an example of a sub-vector-supporting increment/decrement instruction; and

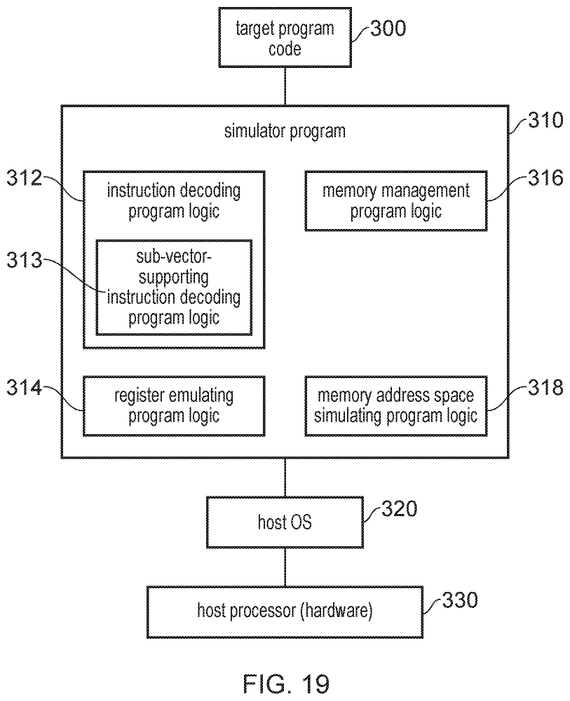

FIG. 19 illustrates a simulator implementation.

An apparatus has processing circuitry to perform data processing, and instruction decoding circuitry to control the processing circuitry to perform the data processing in response to decoding of program instructions defined according to a scalable vector instruction set architecture (ISA). The scalable vector ISA (also known as a “vector length agnostic” vector ISA) supports vector instructions operating on vectors of scalable vector length to enable the same instruction sequence to be executed on apparatuses with hardware supporting different maximum vector lengths. This is useful because it allows different hardware designers of processor implementations to choose different maximum vector lengths depending on whether their design priority is high-performance or reduced circuit area and power consumption, while software developers need not tailor their software to a particular hardware platform as the software written according to the scalable vector ISA can be executed across any hardware platform supporting the scalable vector ISA, regardless of the particular maximum vector length supported by a particular hardware platform. Hence, the vector length to be used for a particular vector instruction of the scalable vector ISA is unknown at compile time (neither defined to be fixed in the ISA itself, nor specified by a parameter of the software itself). The operations performed in response to a given vector instruction of the scalable vector ISA may differ depending on the vector length chosen for a particular hardware implementation (e.g. hardware supporting a greater maximum vector length may process a greater number of vector elements for a given vector instruction than hardware supporting a smaller maximum vector length). An implementation with a shorter vector length may therefore require a greater number of loop iterations to carry out a particular function than an implementation with a longer vector length.

While the scalable vector ISA can be very useful to enable development of platform-independent program code which can easily be ported between processor implementations with differing maximum vector lengths, there may be a significant amount of legacy code which was compiled assuming a known vector length. It may take a considerable amount of software development effort to redevelop the legacy software for use with the scalable vector ISA. This is particularly the case because some software techniques typically used to improve performance for vectorised code, such as software pipelining or loop unrolling, may rely on the vector length used for the instructions being known at compile time. Therefore, it may not be straightforward to remap instructions of the non-scalable vector ISA to instructions of the scalable vector ISA as some techniques used in legacy code may not be available in the scalable vector ISA. This may be a significant barrier to adoption of the scalable vector ISA and may result in some software developers choosing not to use the scalable vector ISA, so that a significant amount of software executing on newer processors supporting the scalable vector ISA may still use a less performance-efficient non-scalable vector ISA which uses relatively short maximum vector length, even on a processor implementation supporting a large maximum vector length using the scalable vector ISA (that processor implementation may also support the non-scalable vector ISA for backwards compatibility reasons). This means that the full performance capability of the hardware may not be used for many programs.

In the examples discussed below, the instruction decoding circuitry and the processing circuitry support, within the scalable vector ISA, a sub-vector-supporting instruction which treats a given vector as comprising a plurality of sub-vectors with each sub-vector comprising a plurality of vector elements and each sub-vector having equal sub-vector length. In response to the sub-vector-supporting instruction, the instruction decoding circuitry controls the processing circuitry to perform an operation for the given vector at sub-vector granularity. This helps to reduce the software development effort required to enable adoption of the scalable vector ISA because each vector of a non-scalable vector ISA can be mapped to one of the sub-vectors of a vector in the scalable ISA. This makes mapping non-scalable software to scalable software simpler and therefore reduces the barrier to use of the scalable vector ISA, making it more likely that a greater fraction of code executing on an apparatus supporting the scalable vector ISA is actually using the scalable vector ISA, which will tend to improve average performance across a range of processor implementations because those higher-end processors which support longer vector lengths may be more likely to be able to make use of those longer vector lengths to improve performance.

Each sub-vector may have a sub-vector length which is known at compile time for a given instruction sequence to be executed using the sub-vector-supporting instruction. This is helpful because it allows a vector operand or result of the scalable vector ISA to be defined as a “vector of vectors” comprising a number of smaller sub-vectors each of known vector length, so that multiple vectors defined according to software written using a non-scalable vector ISA can be combined into a larger vector according to the scalable vector ISA. As the length of each sub-vector is known at compile time, any performance-improving software techniques relying on knowledge of vector length at compile time can be applied at the granularity of sub-vectors, making it much easier for a software developer to map code written according to the non-scalable vector ISA into code defined according to the scalable vector ISA while retaining those software techniques.

How many sub-vectors are comprised by the given vector is unknown at compile time for a given instruction sequence to be executed using the sub-vector-supporting instruction. In other words, the overall vector length for the given vector may be a scalable vector length as permitted by the scalable vector ISA (which may define a variety of maximum vector lengths which may be permitted for different processor implementations). This means that the sub-vector-supporting instruction can still benefit from the platform-independent properties of the scalable vector ISA while supporting a range of different performance/power points. Nevertheless, software optimisations which rely on knowledge of a vector length to be used as a granularity for vectorisation can still be used because they can be applied with reference to the sub-vectors of known sub-vector length before a variable number of sub-vectors can be accommodated in a larger given vector of scalable vector length using the sub-vector-supporting instruction. For example, a variable number of iterations of a vectorised loop which previously would have been implemented in vectorised form using a non-scalable vector ISA can be mapped to a vectorised loop in the scalable vector ISA with each iteration of the original vectorised loop corresponding to one of the sub-vectors of the vectors processed by sub-vector supporting instructions of the scalable vector ISA. This makes compilation and software development of code much simpler as it may avoid the need to revert from vectorised non-scalable code to a scalar loop before converting the scalar loop back into vectorised scalable code according to the ISA-instead it may be simpler to map vector instructions of the non-scalable ISA direct to scalable vector instructions of the scalable ISA without an intervening devectorisation step (other compilers may simply compile directly for the scalable ISA including sub-vector-processing instructions without basing the compilation on previous code compiled for a non-scalable ISA). The sub-vector length known at compile time may be independent of the vector length used for the given vector, so that the sub-vector length is the same for a given instruction of a given piece of software regardless of the actual vector length used for the overall given vector by a given hardware implementation.

In response to the sub-vector-supporting instruction, the instruction decoding circuitry may control the processing circuitry to process each of the sub-vectors in response to the same instance of executing the sub-vector-supporting instruction. For example, each of the operations performed at sub-vector granularity could be processed in parallel. Alternatively, the operations performed at sub-vector granularity could be processed sequentially, or in part sequentially and in part in parallel, or in a pipelined manner. Regardless of the exact timing at which the various operations performed at sub-vector granularity, each of the operations at sub-vector granularity is performed in response to a single instance of execution of the sub-vector supporting instruction, so that the SIMD benefits of vector ISAs can be realised.

There are a number of ways in which the sub-vector length could be known at compile time. For some implementations of the scalable vector ISA, the ISA may define the sub-vector length as a variable software-defined parameter which can be specified by the software code itself, so as to allow the software to select between two or more different sub-vector sizes. For example, this could help provide support for remapping code from two or more different non-scalable vector ISAs with different non-scalable vector lengths.

However, in one example each sub-vector may have a sub-vector length of an architecturally-defined fixed size which is independent of a vector length used for the given vector. This can simplify the architecture and avoid any need for software to specify the sub-vector length. Instead, the sub-vector length may be fixed in the architecture definition of the sub-vector-supporting instruction defined in the scalable vector ISA.

The architecturally-defined fixed size may correspond to an architecturally-defined maximum vector length prescribed for vector instructions processed according to a predetermined non-scalable vector ISA. For example, the predetermined non-scalable vector ISA could be the “Advanced SIMD” architecture (also known as the Neon™ architecture) provided by Arm® Limited of Cambridge, UK.

For example, the architecturally-defined fixed size of the sub-vector length may be 128 bits. This is useful for compatibility with the Advanced SIMD architecture which defines a maximum vector length of 128 bits.

It is also possible to implement sub-vector-supporting instructions targeting other non-scalable vector ISAs, in which case the sub-vector length may vary depending on the particular ISA targeted.

Also, it is possible to implement the sub-vector-supporting instructions without intending to target any particular non-scalable vector ISA, but simply to choose a given fixed sub-vector length independent of any aim to emulate a length used in a particular non-scalable vector ISA. Even if there is no particular non-scalable vector ISA being targeted, it can still be useful to define the sub-vectors have a sub-vector length of an architecturally-defined fixed size, to enable software developers and compilers to make use of software performance optimisations that depend on compile-time knowledge of that fixed size.

The sub-vector-supporting instruction may support variable element size, so that each vector elements of each sub-vector has a variable element size selected from two or more different sizes supported by the scalable vector ISA. The sub-vector length may be independent of which element size is used for each vector element within each sub-vector. Hence, the same sub-vector length may be used regardless of whether the selected element size is a larger element size or smaller element size. The number of vector elements define per sub-vector may correspond to the ratio between the sub-vector length and the selected element size. The selected element size may be defined by a software-specified parameter of the instruction sequence comprising the sub-vector-supporting instruction, and so is known at compile time. Hence, as both the sub-vector length and the element size may be known at compile time, the number of vector elements provided per sub-vector may also be known at compile time, although the total number of vector elements in the given vector as a whole may be unknown at compile time because the overall vector length of the given vector is unknown at compile time according to the scalable vector ISA.

The operation performed at sub-vector granularity may vary. A number of different sub-vector-supporting instructions can be defined as part of the scalable vector ISA to enable a number of different operations to be performed at sub-vector granularity depending on the choice of the programmer or compiler.

In some examples, for at least one sub-vector-supporting instruction, the operation performed at sub-vector granularity is an operation performed, for each sub-vector, on vector elements within that sub-vector, independent of elements in other sub-vectors. Hence, this can allow operations, which in a non-scalable vector ISA would have been performed using a number of separate vector instructions (each operating on a respective vector of non-scalable vector length known at compile time), to be performed in a single sub-vector-supporting instruction (e.g. those separate vector instructions may correspond to different iterations of a loop written in the code of the non-scalable vector ISA).

In some examples, for at least one sub-vector-supporting instruction, the operation performed at sub-vector granularity is an operation performed, for each element position within a sub-vector, on respective vector elements at that element position within each of the plurality of sub-vectors. Such an instruction could be useful, for example, to replicate processing which would have been performed using a sequence of vector instructions within a single loop iteration where those vector instructions would have combined data values in the corresponding element positions within a number of vector operands specified for that sequence of vector instructions.

In some examples, for at least one sub-vector-supporting instruction, the operation performed at sub-vector granularity is an operation to set, or perform an operation depending on, selected predicate bits of a predicate value, where the selected predicate bits are predicate bits corresponding to sub-vector-sized portions of a vector. This may differ from many instructions of the scalable vector ISA which may set or interpret the predicate at granularity of individual vector elements smaller than the sub-vector length. Such sub-vector-supporting predicate-setting or predicate-dependent instructions can be useful for allowing processing of entire sub-vectors to be selectively masked in certain instances, e.g. in conditions where corresponding code of a non-scalable vector ISA would have masked out an entire iteration of a vectorised loop performed on vectors of a particular vector length known at compile time.

In some examples, the scalable vector ISA may support at least one variant of a sub-vector-supporting permute instruction. In response to a sub-vector-supporting permute instruction, the instruction decoder controls the processing circuitry to set, for each sub-vector of a vector result, the sub-vector to a permutation of one or more vector elements selected from among vector elements within a correspondingly-positioned sub-vector of at least one vector operand. The sub-vector-supporting permute instruction could be incapable of setting a vector element of a given sub-vector of the vector result based on bits of vector elements at a different, non-corresponding, sub-vector position within one of the vector operands. By performing the permutation at sub-vector granularity, rather than across the entire vector length of the given vector as a whole, this may allow the behaviour of the sub-vector-supporting permute instruction to mirror behaviour of a number of separate non-scalable permute instructions defined in a non-scalable vector ISA which assume a known vector length for the permutation, while still enabling the number of such sub-vector-granularity permutations performed for a given instruction to be scaled based on the implemented vector length supported in hardware according to the scalable vector ISA.

In some examples, the scalable vector ISA may support at least one variant of a sub-vector-supporting reduction instruction. In response to a sub-vector-supporting reduction instruction, the instruction decoder may control the processing circuitry to perform at least one reduction operation at sub-vector granularity, each reduction operation to reduce a plurality of vector elements of an operand vector to a single data value within a result. Such a reduction operation when performed at granularity of an individual sub-vector may give a different result to a corresponding reduction operation performed across the entire vector length, as vector elements in different sub-vectors may not be combined with each other. Such reductions can be useful to emulate processing which in a sequence of non-scalable vectorised code might have been implemented by a sequence of multiple instructions within a given loop iteration or a series of loop iterations each comprising a single instance of an instruction to combine each element of a vector operand with corresponding elements of an accumulator value tracking the result of similar combinations in any preceding loop iterations.

Different variants of a sub-vector-supporting reduction instruction are possible, which vary in the way in which the reduction is performed at sub-vector granularity.

For example, for an intra-sub-vector sub-vector-supporting reduction instruction, for each reduction operation the plurality of vector elements comprise the respective vector elements within a corresponding sub-vector of the operand vector. Including such an instruction in the ISA can be useful to allow a software developer to use the instruction to emulate, in a scalable architecture with unknown vector length at compile time, behaviour of non-scalable code which performed the reductions across all the vector elements of a single vector operand. The result of each sub-vector granularity reduction could be placed in a different sub-vector of the result value. Alternatively, a variant of the intra-sub-vector sub-vector-supporting reduction instruction could place the result of each sub-vector granularity reduction in respective vector elements of one or more sub-vectors of the result value.

In another variant, for an inter-sub-vector sub-vector-supporting reduction instruction, for each reduction operation the plurality of vector elements comprise the vector elements at corresponding element positions within a plurality of sub-vectors of the operand vector. For this type of instruction, the vector elements that are reduced to a single result are vector elements selected at intervals of the sub-vector length. Including such instruction in the ISA can be useful to allow a software developer to use the instruction to emulate, in a scalable architecture with unknown vector length at compile time, behaviour of non-scalable code which perform the reductions across the vector elements at the same element position within vector is processed in a number of successive loop iterations.

The scalable vector ISA may support any one or more of these types of sub-vector-supporting reduction instructions.

In some examples, the scalable vector ISA may support at least one variant of a sub-vector-supporting load/store instruction. In response to a sub-vector-supporting load/store instruction, the instruction decoder may control the processing circuitry to perform a load/store operation to transfer, at sub-vector granularity, one or more sub-vectors between a memory system and at least one vector register. This can be useful to emulate behaviour of load/store instructions of a non-scalable vector ISA which would have performed corresponding load/store operations on vectors of a known vector length.

The sub-vector-supporting load/store instruction may be a predicated instruction associated with a predicate value. In response to the sub-vector-supporting load/store instruction, the instruction decoder may control the processing circuitry to control, based on predicate bits selected from the predicate value at sub-vector granularity, whether each transfer of the one or more sub-vectors is performed or masked. This may differ from the behaviour of other load/store instructions of the scalable vector ISA which may perform the load/store operation across the entire (scalable) vector length with the predicates selected at a granularity of the element size used for the vector elements of the vector (the element size being smaller than the sub-vector length).

In some examples, the scalable vector ISA may support at least one variant of a sub-vector-supporting increment/decrement instruction. In response to the sub-vector-supporting increment/decrement instruction, the instruction decoder may control the processing circuitry to increment or decrement an operand value based on how many sub-vector-sized portions of a vector are indicated as active by bits of a predicate value selected from the predicate value at sub-vector granularity. This can be helpful for loop control so that a loop control variable used by software to decide whether at least one further loop iteration still needs to be performed can be incremented or decremented according to the number of sub-vectors processed in the latest iteration of the loop (as the number of sub-vectors processed in that loop iteration may not be known at compile time, it can be useful to provide an instruction which enables the number of sub-vectors processed to be deduced and used to update a loop control variable accordingly).

The predicate value used by the sub-vector-supporting increment/decrement instruction to determine how to update the operand value may be one of: a predicate value specified as a predicate operand by the sub-vector-supporting increment/decrement instruction; and a predicate value implied by a predicate pattern identifier specified by the sub-vector-supporting increment/decrement instruction, the predicate pattern identifier specifying a predetermined pattern of predicate bits at sub-vector granularity.

In some examples, the scalable vector ISA may support at least one variant of a sub-vector-supporting predicate-setting instruction. In response to the sub-vector-supporting predicate setting instruction, the instruction decoder may control the processing circuitry to perform a predicate setting operation to set bits of a predicate value at sub-vector-granularity, to indicate which sub-vectors of a vector are active. Such an instruction can be useful to control which sub-vectors are processed by other sub-vector-supporting predicate instructions. Bits of the predicate value set to a particular value (e.g. 0) may cause processing of the corresponding sub-vector to be masked. Such a predicate-setting instruction may be a different instruction to other predicate-setting instructions of the scalable vector ISA which may set the predicate value at granularity of a vector element size which may be smaller than the sub-vector length.

The predicate setting operation for the sub-vector-supporting predicate-setting instruction may comprise setting the predicate value based on one of: a predicate pattern identifier specifying a predetermined pattern of predicate bits to be applied at sub-vector granularity; and sub-vector-granularity comparison operations based on a comparison of a first operand and a second operand. With this approach, the new value of the predicate is not explicitly specified in the sub-vector-supporting predicate setting instruction, but can be defined according to some general pattern which may be scalable for different vector lengths. This is useful because the number of predicate bits to be set may be unknown at compile time due to the scalable vector length.

Various examples of sub-vector-supporting instructions are described above. It will be appreciated that any given implementation of the scalable vector ISA need not support all of these types instructions. Any one or more of the described instructions in this application could be implemented.

The techniques discussed above may be implemented within a data processing apparatus which has hardware circuitry provided for implementing the instruction decoder and processing circuitry discussed above.

However, the same technique can also be implemented within a computer program which executes on a host data processing apparatus to provide an instruction execution environment for execution of target code. Such a computer program may control the host data processing apparatus to simulate the architectural environment which would be provided on a hardware apparatus which actually supports target code according to the scalable vector instruction set architecture, even if the host data processing apparatus itself does not support that architecture. The computer program may have instruction decoding program logic which emulates functions of the instruction decoding circuitry discussed above. For example, the instruction decoding program logic generates, in response to a given instruction of the target code, a corresponding sequence of code in the native instruction set of the host data processing apparatus, to control the host data processing apparatus to perform corresponding function to the decoded instruction. The instruction decoding program logic includes sub-vector-supporting instruction decoding program logic to decode a sub-vector-supporting instruction as discussed above, to control the host data processing apparatus to perform an operation for a given vector at sub-vector granularity. Such a simulation program can be useful, for example, when legacy code written for one instruction set architecture is being executed on a host processor which supports a different instruction set architecture. Also, the simulation can allow software development for a newer version of the instruction set architecture to start before processing hardware supporting that new architecture version is ready, as the execution of the software on the simulated execution environment can enable testing of the software in parallel with ongoing development of the hardware devices supporting the new architecture. The simulation program may be stored on a storage medium, which may be an non-transitory storage medium.

Specific examples are now described with reference to the drawings. It will be appreciated that the claims are not limited to these particular examples.

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 (an example of instruction decoding circuitry) for decoding the fetched program instructions to generate micro-operations (decoded instructions) to be processed by remaining stages of the pipeline; an issue stage 12 for checking whether operands required for the micro-operations are available in registers 14 and issuing micro-operations for execution once the required operands for a given micro-operation are available; an execute stage 16 (an example of processing circuitry) for executing data processing operations corresponding to the micro-operations, by processing operands read from the registers 14 to generate result values; and a writeback stage 18 for writing the results of the processing back to the registers 14. It will be appreciated that this is merely one example of possible pipeline arrangement, and other systems may have additional stages or a different configuration of stages. For example, in an out-of-order processor a register renaming stage could be included for mapping architectural registers specified by program instructions or micro-operations to physical register specifiers identifying physical registers in the registers 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar processing unit 20 (e.g. comprising a scalar arithmetic/logic unit (ALU) 20 for performing arithmetic or logical operations on scalar operands read from the registers 14); a vector processing unit 22 for performing vector operations on vectors comprising multiple vector elements; and a load/store unit 28 for performing load/store operations to access data in a memory system 8, 30, 32, 34. Other examples of processing units which could be provided at the execute stage could include a floating-point unit for performing operations involving values represented in floating-point format, or a branch unit for processing branch instructions.

The registers 14 include scalar registers 25 for storing scalar values, vector registers 26 for storing vector values, and predicate registers 27 for storing predicate values. The predicate values 27 may be used by the vector processing unit 22 when processing vector instructions, with a predicate value in a given predicate register indicating which vector elements of a corresponding vector operand stored in the vector registers 26 are active vector elements or inactive vector elements (where operations corresponding to inactive data elements may be suppressed or may not affect a result value generated by the vector processing unit 22 in response to a vector instruction).

A memory management unit (MMU) 36 controls address translations between virtual addresses (specified by instruction fetches from the fetch circuitry 6 or load/store requests from the load/store unit 28) and physical addresses identifying locations in the memory system, based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached in a translation lookaside buffer (TLB) 38 which is a cache maintained by the MMU 36 for caching page table entries or other information for speeding up access to page table entries from the page table structure shown in memory.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline arrangement, and the processor may include many other elements not illustrated for conciseness.

The processing pipeline 4 supports a scalable vector ISA, which means that the vector instructions of the ISA may be processed without it being known at compile time (the time at which the executed instructions were compiled by a compiler) what vector length will be used for execution of those vector instructions. This enables a variety of different processing apparatuses supporting different maximum vector lengths to execute the same software code, to avoid the burden on the software developer in producing software code suitable for execution across a range of processing platforms. This means that the hardware designer of a given processing apparatus has freedom to select the implemented maximum vector length depending on the designer's preferred performance/power requirements (systems aimed at higher performance may select a longer maximum vector length than systems aimed at better energy efficiency).

FIG. 2 illustrates an example of architectural state for a scalable vector ISA. The ISA defines, as the vector registers 26, a number of scalable vector registers (e.g. 32 vector registers, Z0 to Z31) which have, for a given hardware implementation, an implementation-chosen vector length that can be any multiple of a certain unit size up to a certain architecturally-defined maximum length. For example, in this example the unit size is 128 bits, and the architecture supports the maximum vector length being any multiple of 128 bits between 128 bits and 2048 bits (i.e. the vector length for a given processor is LEN*128 bits where 1≤LEN≤16). This differs from a non-scalable vector architecture where the registers may have a fixed architectural-defined vector length of 128-bits, say (see the registers labelled V0 to V31 in FIG. 2). The example shown in FIG. 2 is based on the scalable vector ISA being the “Scalable Vector Extension” (SVE) provided by Arm® Limited, and the non-scalable vector ISA being the “Advanced SIMD” architecture (Neon™) provided by Arm® Limited. Even if supporting vector lengths greater than 128 bits according to the scalable vector ISA, the instruction decoder 10 and processing circuitry 16 may also support the non-scalable vector ISA for backwards compatibility reasons, and instructions of the non-scalable vector ISA may reference registers V0-V31 of fixed length (e.g. 128 bits)-in practice these registers may be represented using a portion of the longer registers accessible to instructions of the scalable vector ISA, so that the scalable vector registers Z0-Z31 and non-scalable vector registers V0-V31 may share hardware storage circuitry.

Of course, other examples could be based on different scalable and non-scalable architectures and so the range of sizes available for selection for the scalable vector length and the fixed size specified for the non-scalable vector length could differ from that shown in FIG. 2.

As well as the vector registers 26, a number of predicate registers 27 (labelled P0 to P15) are provided, for storing predicate values used to selectively mask operations performed on vector elements of vector operands provided using the vector registers 26. The predicate registers 27 may have a bit per vector element in the vector registers 26 when defined according to the minimum vector element size supported by the ISA when the maximum vector length supported in hardware is used (the maximum vector length here refers to the selected size LEN*128 used by a particular hardware implementation, not the maximum vector length (e.g. 2048 bits) permitted by the architecture for any hardware implementation). For example, if the minimum element size is 8 bits, then for the example of LEN*128 bit vector registers, each predicate register may have size LEN*16 bits. FIG. 3 shows an example of predication applied to vectors on an element-by-element basis. Instructions may define a variable element size, for example FIG. 3 shows how a 256-bit vector could be logically divided into either 64-bit or 32-bit elements (other element sizes may also be possible, e.g. 16 or 8-bit elements). The predicate register 27 specified for a given vector stored in a vector register 26 specifies a number of predicate bits sufficient to be able to specify a separate predicate bit for each vector element when the minimum element size is used, but at larger element sizes not all of the predicate bits need to be read and instead the predicate bits may be read at intervals which correspond to the element size. For example, for 64-bit elements one in every eight predicate bits may be read as shown in the top example of FIG. 3, while for 32-bit elements one in every four predicate bits may be read (at 8-bit element size, each predicate bit may be read). When a predicate bit is set to 1 then the corresponding element is considered active while vector elements with the corresponding predicate bits set to 0 are considered inactive. Elements of a result vector which correspond to inactive vector elements may be masked out from being updated based on the result of a vector operation (predicated instructions may include zeroing-predication variants where the masked out result elements are set to 0, or merging-predication variants where the masked out result elements are set to the same value as corresponding elements within the destination register prior to the vector instruction being executed).

As shown in FIG. 2, the registers 14 can also include some control registers 29 (labelled ZCR) which can be used by more privileged software to limit the maximum vector length which is usable by software executing in a less privileged state. For example, to save power a given piece of software could be limited so that it cannot make use of the full vector length supported in hardware. Nevertheless, even if the more privileged software applies a limit on vector length, the vector length for the application software is still unknown at compile time because it will not be known whether the actual implemented vector length in a particular processor will be greater or less than the limit defined in the control register 29 (for implementations with a smaller maximum vector length than the limits defined in the control register 29, a smaller vector length than indicated by the limit will be used).

The vector length agnostic property of the scalable vector ISA is useful because within a fixed encoding space available for encoding instructions of the ISA, it is not feasible to create different instructions for every different vector length that may be demanded by processor designers, when considering the wide range of requirements scaling from relatively small energy-efficient microcontrollers to servers and other high-performance-computing systems. By not having a fixed vector length known at compile time, multiple markets can be addressed using the same ISA, without effort from software developers in tailoring code to each performance/power/area point.

To achieve the scalable property of the scalable vector ISA, the functionality of the vector instructions of the scalable vector ISA is defined in the architecture with reference to a parameter (e.g. LEN as shown in FIG. 2) which indicates the vector length in use (when considering the maximum vector length supported in hardware and any software-defined limitations using the control registers 29), where that parameter LEN is unknown at compile time. Hence, execution of the same vector instruction on different systems may produce different results (typically varying in terms of the number of vector elements generated, a subset of which may have the same result values on different platforms, but in general platforms implementing a greater vector length may generate additional vector elements in comparison with a platform implementing a smaller vector length). Predicates may be used to control which elements are generated in a given instance of an instruction and can be set based on vector length agnostic principles such as by using comparison instructions to automatically generate the values of predicate for a particular loop iteration or applying some generally-defined predicate pattern which can scale to different vector lengths. Certain instructions may update loop control parameters such as an element count value to track how many vector elements have been processed so far so that across a loop as a whole both the implementations with wider and narrow vector lengths may eventually achieve the same results but with different levels of performance, since the implementation with a wider vector length may require fewer loop iterations than an implementation with a narrower vector length.

FIG. 4 shows a worked example showing how the same sequence of instructions can be processed differently on different hardware implementations using a different vector length. In this example, the code example is to carry out a double precision floating-point operation ‘daxpy’ (double-precision Ax plus y) to calculate y [i]=a*x[i]+y [i] for two arrays x[i], y[i] of input values where 0≤i<n. This can be implemented in a vectorised loop using a set of instructions from a scalable vector ISA as follows:

| 1 | // x0 = &x[0], x1 = &y[0], x2 = &a, x3 = &n | |
|---|---|---|
| 2 | daxpy_: | |
| 3 | ldrsw x3, [x3] | // x3=*n |
| 4 | mov x4, #0 | // x4=i=0 |
| 5 | whilelt p0.d, x4, x3 | // p0=while(i++<n) |
| 6 | ld1rd z0.d, p0/z, [x2] | // p0:z0=broadcast(*a) |
| 7 | .loop: | |
| 8 | ld1d z1.d, p0/z, [x0, x4, lsl #3] | // p0:z1=x[i] |
| 9 | ld1d z2.d, p0/z, [x1, x4, lsl #3] | // p0:z2=y[i] |
| 10 | fmla z2.d, p0/m, z1.d, z0.d | // p0?z2+=x[i]*a |
| 11 | st1d z2.d, p0, [x1, x4, lsl #3] | // p0?y[i]=z2 |
| 12 | incd x4 | // i+=(VL/64) |
| 13 | .latch: | |
| 14 | whilelt p0.d, x4, x3 | // p0=while(i++<n) |
| 15 | b.first .loop | // more to do? |
| 16 | ret | |

FIG. 4 shows processing of these instructions for one example using 128-bit vector length and another example using 256-bit vector length. The variable a and arrays x[ ] and y[ ] are data stored in memory. The registers x0-x4 are scalar registers. The register p0 is a predicate register. The registers z0-z2 are vector registers, which in the first example are 128-bit registers and in the second example are 256-bit registers (accordingly, the predicate register p0 is a longer register in the 256-bit example compared to the 128-bit example). Solid outlined boxes indicate active elements processed or set by a given instruction, while dashed outlined boxes indicate either inactive elements masked by predication or registers which are not used for a given instruction at all. Note that the instruction numbering shown in FIG. 4 indicates the program order of the sequence of decoded instructions executed by the processing circuitry 16 (which differs from the numbering of the compiled code shown above, since some instructions may be executed multiple times and the branch point labels numbered in the example above are not numbered in FIG. 4). Nevertheless, the same instruction sequence is shown in FIG. 4 as shown above.

In both 128-bit and 256-bit examples, the vector instructions scale to the number of vector elements that can fit within the corresponding vector length. In this example, the element size used is 64 bits so that there are 2 vector elements per vector in the 128-bit example and 4 vector elements per vector in the 256-bit example. Accordingly, only two predicate bits of p0 are used in the 128-bit example and only four predicate bits of p0 are used in the 256-bit example (in practice, the register p0 may include a greater number of predicate bits to enable smaller vector element sizes to be supported).

The whilelt, incd and b.first instructions are loop control instructions which set predicates and update a loop count value according to the supported vector length and conditionally branch back to the start of the loop depending on a comparison of the loop count value. The other instructions are load/store instructions or vector processing instructions which process a number of vector elements according to the supported vector length.

The incrementing instruction incd increments the loop counter based on the number of vector elements processed in the corresponding loop iteration (e.g. VL/ES where VL is the vector length and ES is the vector element size). The predicate setting instructions whilelt uses a comparison between the loop counter (i, represented by register x4 in the instruction sequence) and the termination limit (n, represented by register x3 which is loaded from memory by the load instruction at line 3 of the code example above) to set the predicate depending on whether various incremented versions of the loop counter are less than (It) the limit value. For those elements where the incremented loop counter is still less than the limit value, the predicate is set to true, while the predicate is set to false once the incremented loop counter reaches the termination limit (in this example, this occurs for the fourth element processed for instruction 2 in the 256-bit example, but for the 2-element vector in the 128-bit example this limit is not yet reached on the first pass and will only be reached by a subsequent predicate setting instruction (the whilelt instruction shown at line 14 in the code example above) that is executed to determine there is still another vector element to process (see the 9th instruction in decoded program order shown in the 128-bit example of FIG. 4) and so the branch instruction (instruction 10 in decoded program order) loops back for another pass. On the next pass, the whilelt instruction (16th instruction in decoded program order) now determines that all the predicates are “false” and so this time the branch instruction does not take the branch and so the loop ends. In contrast, for the 256-bit example, only one pass was needed which masked out the effects of the fourth element in each vector register.

Note how ultimately the result produced by the instruction sequences the same for both the 128-bit and 256-bit example (the data stored to memory for array y [ ] has the same values 3, 50, 41, 32 (from most significant address to least significant address), but the 128-bit example has obtained its result in two loop iterations while the 256-bit example only needed one loop iteration. Hence, the instructions at lines 8-15 in the code example above were required to be decoded and executed twice in the 128-bit example (see instructions 4 to 17 numbered in decoded program order for the 128-bit example in FIG. 4).

While the scalable vector ISA can be very useful to enable platform-independent code to be developed supporting a range of different hardware implementations, nevertheless many software programs in use have been optimised specifically for a non-scalable vector ISA supporting a fixed length vector unit, such as the 128-bit vector unit provided for systems compliant with the Neon™ non-scalable vector ISA of Arm® Limited. For backwards compatibility, systems supporting the scalable vector ISA may also support the instructions of the non-scalable vector ISA to ensure such legacy software can still be executed. However, this means that even if the hardware supports greater vector lengths, the non-scalable software cannot benefit from the extra performance that would be available in hardware.

It may be desirable for the program code written in the non-scalable vector ISA to be redeveloped using instructions of the scalable vector ISA, as this can open up greater performance opportunities, exploiting the longer vector lengths available on many hardware implementations of the scalable vector ISA. However, if it is attempted to rewrite a program written for a non-scalable vector ISA (where the vector length is known at compile time) into program code written for a scalable vector ISA (where the vector length is unknown at compile time), this may require considerable effort for the programmer or the compiler writer. The instructions of the non-scalable vector ISA may not map to scalable vector instructions in a simple manner, because often the program code in the non-scalable ISA may include specific optimisations which were chosen dependent on the knowledge of a fixed vector length known at compile time (e.g. 128 bits), and if it cannot be known what vector next will be used at compile time, this may prevent use of some such optimisations, which may in some cases prevent use of a vectorised loop at all in the scalable vectorised code altogether.

For example, the following C code may implement a partial sum reduction (e.g. this may be an operation from a digital signal processing application):

```
for (int biquad = 0; sample < num_samples; ++sample) {
  tmp = acc;
  acc += (((int32_t) coeff[biquad].b1 * state[biquad].x1 +
    (int32_t) coeff[biquad].b2 * state[biquad].x2) >> 14) +
    (((int32_t) coeff[biquad].a1 * state[biquad].y1 +
    (int32_t) coeff[biquad].a2 * state[biquad].y2) >> 14);
  state[biquad].x2 = state[biquad].x1;
  state[biquad].x1 = tmp;
  state[biquad].y2 = state[biquad].y1;
  state[biquad].y1 = acc;
}
```

In the code above, the result of the multiply-add operations in each iteration is accumulated in acc and stored in state [biquad].y1. After being vectorized, each element of the vector used to store the value of state [biquad].y1 should store the partial sum of the accumulation (Element 0 should store the value of acc in the 0th iteration, Element 1 should store the resultant value of acc after the first two iterations, and so on).

On a non-scalable vector ISA, this partial sum reduction can be achieved by broadcasting each one of the four elements into a new vector register and partially accumulating these four vector registers using the mla (multiply-accumulate) instructions, as shown below:
. . .
dup v17.4h, v16.h [0]
dup v18.4h, v16.h [1]
dup v19.4h, v16.h [2]
dup v20.4h, v16.h [3]
add v6.4h, v6.4h, v17.4h
mla v6.4h, v18.4h, v29.4h
mla v6.4h, v19.4h, v30.4h
mla v6.4h, v20.4h, v31.4h
. . .
   Here, the first duplication (dup) instruction sets all vector elements of vector register v17 equal to element 0 of vector register v16, the second dup instruction sets all vector elements of vector register v18 equal to element 1 of vector register v16, and so on. There is one dup per vector element of register v16. As the vector length in the non-scalable vector ISA is known at compile time, then given the size of the vector elements, the compiler can work out how many dup instructions to include (four in this example based on 4 32-bit elements per 128-bit vector).

However, in a scalable vector ISA this partial sum reduction cannot be performed in the same way, because at compile time the vector length is unknown and therefore the compiler does not know how many dup instructions should be included. This may prevent the successful vectorisation of the scalar loop defined in the C code, and may force the scalable vector code to resort to a scalar loop so that the benefits of vectorisation cannot be realised.

This is just one example of a software optimisation which may rely on compile-time knowledge of the vector length. Other examples may include loop unrolling, which reduces the number of loop control instructions needed to be executed by mapping a certain number of original loop iterations to a smaller number of loop iterations each comprising a greater number of instructions, with one iteration of the “unrolled” loop corresponding to multiple iterations of the original loop; and software pipelining, where a compiler re-orders the execution of instructions of the loop so that some instructions of a later loop iteration may be executed ahead of instructions from an earlier loop iteration.

FIG. 5 schematically illustrates an example of a technique which can help with this problem. A vector having the scalable vector length (which is unknown at compile-time) is logically treated as composed of a scalable number of sub-vectors, each sub-vector having an equal sub-vector length. The sub-vector length is known at compile-time. For example, each sub-vector may be of a fixed size (e.g. 128 bits) corresponding to the fixed vector length in a non-scalable vector architecture such as Neon™, or may simply be an arbitrary fixed size defined in the scalable vector ISA (irrespective of any correspondence with an existing non-scalable vector ISA). Alternatively, in some implementations of the scalable vector ISA, there may be the ability for software to specify the sub-vector length from among two or more options, so that the sub-vector length is known (software-defined) at compile time but could vary for different instances of an instruction making use of this sub-vector approach. As the sub-vector length is known at compile time, but the overall vector length is not, the total number of sub-vectors that fit within the vector is also unknown at compile time and can be scalable depending on the particular vector length chosen for a particular hardware implementation executing the instruction designed to support the sub-vector approach. Each sub-vector has a variable number of vector elements and the size of each vector element may be variable and selected by software from a number of options (e.g. 8, 16, 32 or 64 bits). Hence, while the size and number of vector elements per sub-vector may be known at compile time, the number effect elements in the whole vector may be variable and unknown at compile time. The sub-vector length may be independent of both the overall vector length used by the hardware and the vector element size specified for a given instruction.

With this approach, since the sub-vector length is known, it becomes much simpler to convert code compiled for use with a non-scalable vector ISA (assuming a fixed vector length) to code compiled for use with the scalable vector ISA (using sub-vector-supporting instructions which assume sub-vectors of known sub-vector length but allow for scalable overall vector length). Also, even if compiling directly for the scalable vector ISA supporting the sub-vector-supporting instructions (without starting from non-scalable vectorised code), the sub-vector-supporting instructions can be useful to allow software performance-improving techniques such as those discussed above to be applied which would not otherwise be possible for scalable vector instructions which operate at element-by-element or whole-vector granularity in a vector of scalable length, rather than at granularity sub-vectors of fixed size.

Hence, as discussed in the examples below, and number of sub-vector-supporting instructions may be defined which control the processing circuitry 16 (e.g. the vector processing unit 22 and/or load/store unit 28) to perform operations at granularity of sub-vectors rather at granularity of individual elements or granularity of the overall vector). The operations performed at granularity of sub-vectors can be performed in parallel, sequentially, part in parallel and part sequentially, or in a pipelined manner, in response to a single instance of execution of a sub-vector-supporting instruction (hence, it is not necessary to use predicate values set between respective instances of executing the sub-vector-supporting instruction to partition the vector into sub-vectors with each sub-vector processed in a separate pass through the sub-vector-supporting instruction).

It is not essential to provide sub-vector-supporting instructions corresponding to all vector operations which might be desired to be performed on vector operands. Many operations (e.g. add or multiply) may be applied at an element-by-element granularity and so may give the correct results even when applied to operands designed to support the vector-of-vectors approach shown in FIG. 5. Hence, sub-vector-granularity instructions may not be possible for certain types of processing operation. However, for some types of processing operations, such as permutations or reductions which would normally be applied across the whole vector, it can be useful to define sub-vector-supporting instructions which apply corresponding operations at granularity of sub-vectors, to give a different processing result. Similarly, it can be useful to implement certain types of load/store instructions and loop control or predicate setting instructions which operate at sub-vector granularity (e.g. by setting or reading predicate bits at granularity of sub-vectors rather than individual elements). By including such instructions in a scalable vector ISA, this can make it much more straightforward to redevelop program code previously optimised for a non-scalable vector ISA to use the scalable vector ISA, enabling that codes to achieve better performance when executed on the higher-end processor implementations which use larger vector length supported by the scalable vector ISA.

FIG. 6 shows a flow diagram illustrating processing of a sub-vector-supporting instruction. At step 100, the instruction decoder 10, which supports the scalable vector ISA, decodes the next instruction of the program being executed. At step 102 instruction decoder 10 determines whether the decoded instruction is a sub-vector-supporting instruction. If not, then at step 104 the instruction decoder 10 controls the processing circuitry 16 to perform a processing operation as indicated by the other type of instruction. If the instruction decoded by the instruction decoder 10 is a sub-vector-supporting instruction, then at step 106 the instruction decoder 10 controls the processing circuitry 16 to perform an operation at sub-vector granularity for a given vector treated as comprising two or more sub-vectors each comprising a certain number of vector elements, where each sub-vector has an equal sub-vector length. The sub-vector length is known at compile time. The overall vector length is however not known at compile time, so the number of sub-vectors processed by the instruction is unknown at compile time.

FIGS. 7 to 11 show various examples of sub-vector-supporting permute instructions for applying a permutation operation within each sub-vector of vector operands. In each case, both the input operand(s) for the instruction and the result is a vector considered to be logically divided into a number of sub-vectors each having the sub-vector length (e.g. 128 bits) which is fixed in the architecture or otherwise known at compile time. The overall length of the vector operands and result is scalable and unknown at compile time. For ease of explanation, all the examples discussed below show examples with 32-bit elements, so that there are four vector elements per sub-vector, but it will be appreciated that other examples could use a different element size. For each permutation instruction, all the elements within a given sub-vector of the result are set to a permutation of bits selected from the corresponding sub-vector of one or more operand vectors. It is not possible to set a given element in a given sub-vector of the result depending on bits selected from elements in other sub-vectors of the operand vectors which are at a different relative sub-vector position compared to the given sub-vector of the result. Hence, a corresponding permutation operation is performed multiple times at a sub-vector granularity.

FIG. 7 shows a first example of a duplicating permute instruction DUPQ, where the permutation applied in a given sub-vector of the result Zd is to duplicate a selected element of the corresponding sub-vector of an operand vector Zn to each of the vector elements of the given sub-vector of the result. Which element is to be duplicated is indicated by an immediate index value #imm, which defines an element position relative to the start of the sub-vector. For example, in FIG. 7 the immediate value has a value of 1 indicating that element 1 of each sub-vector of operand Zn is to be duplicated to all the vector element positions in the corresponding sub-vector of the result Zd. Hence, value A1 is copied to the first four element positions of Zd, value B1 is copied to the next four element positions, value C1 is copied to the next four element positions, and so on (since each sub-vector comprises four vector elements in this example). The number of sub-vectors processed using the permutation operation will depend on the particular vector length used by the hardware as permitted by the scalable vector ISA. Nevertheless, as the number of instances of a given vector element that will be duplicated is known at compile time (e.g. 4 in this case), code optimisations such as the one shown above for the partial sum reduction can still be used, to make it easier to adopt the scalable vector ISA while still permitting code optimisations that rely on knowledge of a (sub-) vector length at compile time.

The bottom part of FIG. 7 shows a corresponding duplicating permutation if applied at granularity of the whole vector, as might be expected for a conventional vector instruction. In this case, the immediate index value would define a vector element position relative to the start of the vector operand Zn and the vector element at this position of the vector operand Zn would be copied to every element of the result vector Zd. This clearly demonstrates the difference in results achieved using the sub-vector-supporting variant of the permutation instruction in comparison to a whole-vector permutation instruction.

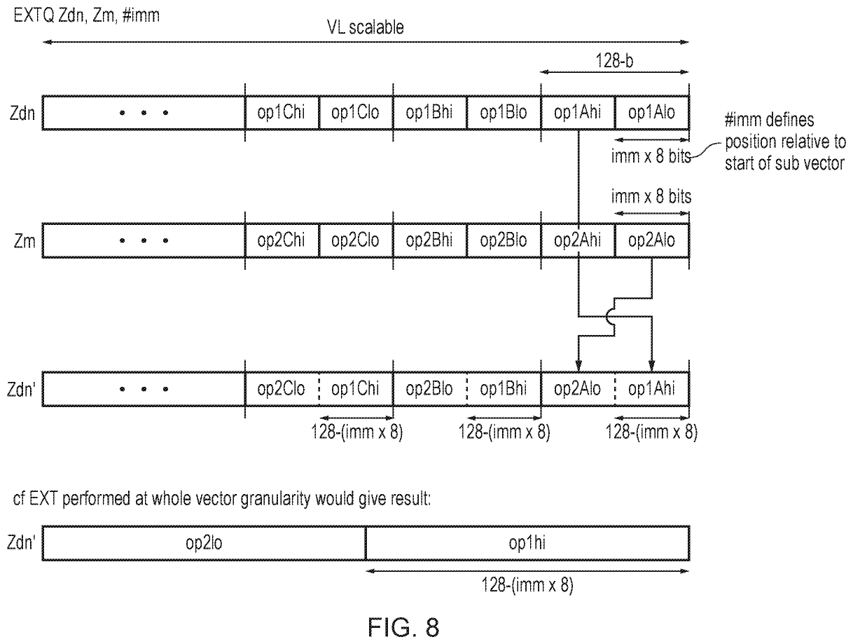

FIG. 8 shows another example of a sub-vector-supporting permute instruction EXTQ. In this example, the permutation applied to each sub-vector is an extraction permutation to set the lower part of each sub-vector of a result Zdn′ to the upper bits of a corresponding sub-vector of a first vector operand Zdn and to set the upper part of each sub-vector to the lower bits of a corresponding sub-vector of a second vector operands Zm. In this example, the encoding is destructive so that the result is written to the same register Zdn used to provide the first vector operand. Other examples could use a constructive encoding which defines a further vector register to provide the first vector operand, separate from the destination register used to store the result. An immediate index value defines the size of the portions extracted from the two operand vectors (e.g. the index may define the position, relative to the start of the sub-vector, at which the upper portion is extracted for the first operand to be copied to the lower bits of the corresponding sub-vector of the result, and remaining bits of the corresponding sub-vector of the result may be filled with bits selected from the least significant end of the second operand). In this particular example, the immediate value selects bit position at byte granularity (in units of 8 bits), so that bits [127−(imm*8): 0] of a given result sub-vector are set equal to bits [127: imm*8] of the corresponding sub-vector in the first operand Zdn and bits [127:128−(imm*8)] of the given result sub-vector are set equal to bits [(imm*8)−1:0] of the second operand Zm. It will be appreciated that other examples could define the immediate value to select at increments of another unit other than 8 bits. This permutation is applied separately at sub-vector granularity, but with each sub-vector permutation using the same immediate value denoting the boundary between the portions extracted from the corresponding sub-vectors of the two operands. Again, FIG. 8 shows how applying this operation at sub-vector granularity is different to a whole vector permutation.

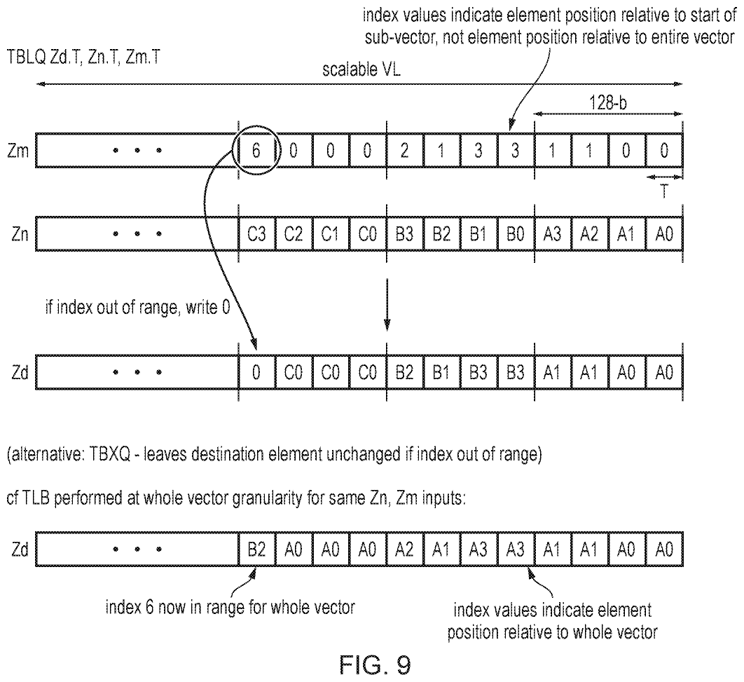

FIG. 9 shows another example if a sub-vector-supporting permute instruction TBLQ, for which a table lookup permutation is applied on a sub-vector by sub-vector basis. In this example, a first vector operand Zm defines a set of index values indicating which elements of a given sub-vector of a second vector operand Zn are to be copied to the corresponding element positions within a corresponding sub-vector of the result vector Zd. The index values are defined relative to the start of the corresponding sub-vector, rather than relative to the entire vector. Hence, for the second sub-vector (corresponding to values B0, B1, B2, B3 in the second operand Zn), the element indices 3, 3, 1, 2 select values B3, B3, B1, B2 (B3 being placed at the least significant element of the sub-vector and B2 in the most significant element) for the corresponding vector elements of the corresponding sub-vector in the result. If a particular index value has a value greater than the maximum vector element index in a given sub-vector, then a zero is written to the corresponding position within the result vector Zd (e.g. see the example of an index value 6 for the most significant vector element position in the third sub-vector, which is greater than the most significant index 3 for the 4 elements (labelled 0 to 3) in a given sub-vector, so 0 is written to the corresponding position in the result Zd). Again, this approach of permutations per sub-vector is different to a whole vector permutation, for which the index values would be defined relative to the whole vector and so applying the whole vector permutation to the same two operands Zm, Zn shown in FIG. 9 would give a different result to the operation performed at sub-vector granularity, as shown in the lower part of FIG. 9.

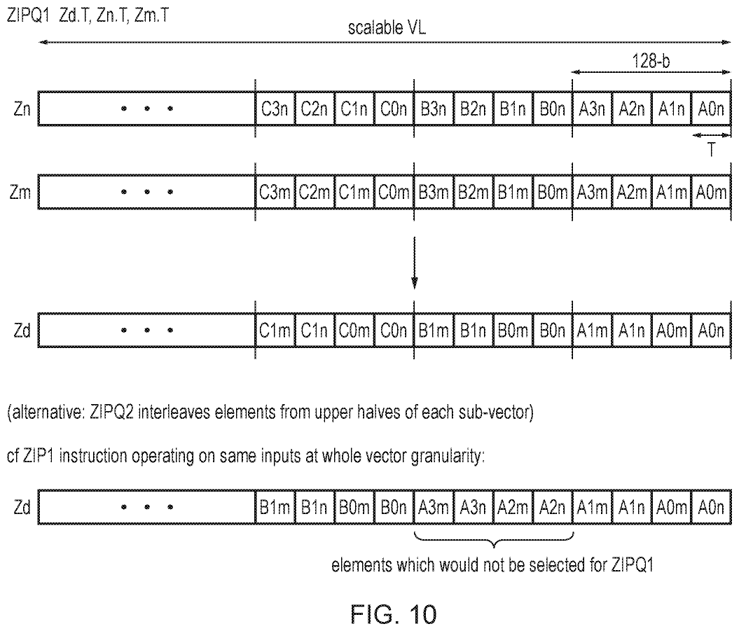

FIG. 10 shows another example of a sub-vector-supporting permute instruction ZIPQ1, where in this case the permutation applied in a given sub-vector is to interleave, within a given sub-vector of the result vector Zd, the elements from the lower halves of corresponding sub-vectors of two vector operands Zn, Zm. This permutation is performed for each of the sub-vectors and again gives different results to the case where a similar permutation was performed at whole vector granularity as shown in the lower part of FIG. 10. While FIG. 10 shows an example of interleaving elements from the lower halves of each sub-vector, a corresponding instruction ZIPQ2 could also be defined to interleave elements from the upper halves of each sub-vector instead.

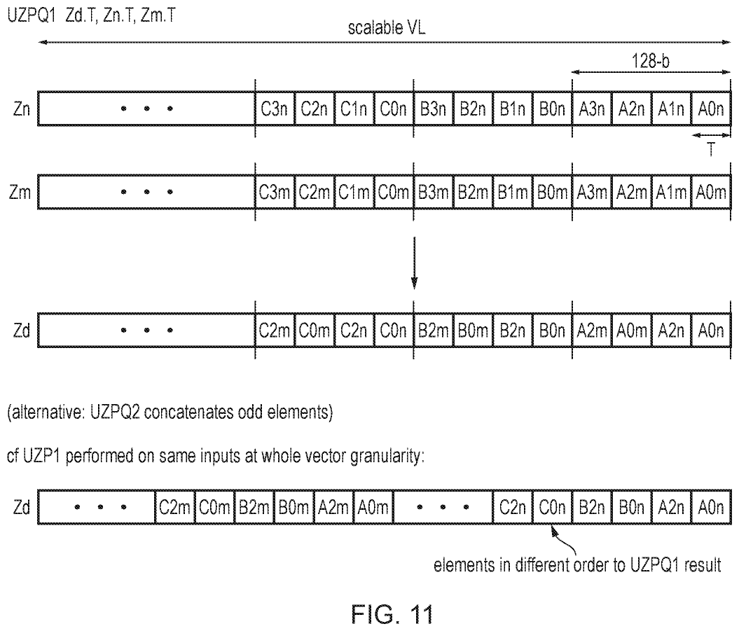

FIG. 11 shows another example of a sub-vector-supporting permute instruction UZPQ1, where in this case the permutation applied in a given sub-vector is to concatenate the even-numbered vector elements of corresponding sub-vectors of two vector operands Zn, Zm within the corresponding sub-vector of a result vector Zd. Again, this yields a result with the elements in a different order to what would be achieved if a similar permutation was applied at granularity of the whole vector. An alternative version UZPQ2 of this instruction could concatenate the odd-numbered elements instead of the even-numbered elements.

FIG. 12 shows an example of an inter-sub-vector reduction instruction which carries out reduction operations at sub-vector granularity, each reduction operation to reduce multiple elements of an operand vector to a single data value within the result vector. This example shows a predicated instruction where the instruction specifies a predicate value Pg associated with the operand vector Zn to indicate which elements are masked. Masked elements do not contribute to the reduction result. For this example, the reduction is performed across correspondingly numbered elements within each sub-vector, and the reduction operator applied in this example is an addition. Hence, element 0 of the result vector Zd is set to the sum of any non-masked elements at position 0 within each of the sub-vectors of the vector operand Zn, element 1 of the result vector Zd is set to the sum of any non-masked elements at position 1 within each of the sub-vectors of the vector operand Zn, and so on for the other element positions (if all of the elements at a given position within each sub-vector are masked, the corresponding element of the result is set to 0). Since the reduction operation reduces the total number of elements, remaining elements of the result vector Zd not filled with a reduction result can be filled with zeroes.

While FIG. 12 shows an example with an addition reduction, a similar reduction operation at sub-vector granularity can be performed for other operations such as AND, exclusive OR (EOR), floating-point addition (FADD), floating-point maximum (FMAX, which determines the maximum of a set of floating-point numbers), floating-point minimum (FMIN, which determines the minimum of a set of floating-point numbers), OR, signed maximum (SMAX, which determines the maximum of a set of signed integers), signed minimum (SMIN, which determines the minimum of a set of signed integers), unsigned maximum (UMAX, which determines the maximum of a set of unsigned integers) and unsigned minimum (UMIN, which determines the minimum of a set of unsigned integers), for example.

As shown in FIG. 13, it is also possible to provide an intra-sub-vector reduction instruction which performs the reduction within each sub-vector, reducing all the elements of a given sub-vector of an input operand Zm to a single data value of the result vector Zd′. That single element can be sign or zero extended to fill the corresponding sub-vector of the result vector Zd′. As shown in FIG. 13, the reduction operation within a given sub-vector can also depend on an element extracted from a given element position (e.g. element position 0) in the corresponding sub-vector of a second vector operand Zd. Again, predication can be applied based on a predicate value Pg which defines the active or inactive elements of the Zm operand (the additional element taken from Zd may always be considered to be active—this element can be used as an accumulator value which tracks the result of a series of previous reductions, hence why it can be useful to use a destructive encoding as shown in FIG. 13 where the result is written to the same register Zd as used to provide the accumulator value).

Regardless of whether the reduction is implemented across corresponding elements of each sub-vector as shown in FIG. 12 or to the elements within a single sub-vector as shown in FIG. 13, this reduction is an operation performed at sub-vector granularity, different to the outcome which would be achieved if the corresponding operation was performed at full vector granularity (reducing all elements of the vector to a single data value), or if the same reduction operation was implemented using an element-wise vector addition instruction (or similar element-wise instruction for other reduction operations) included in a loop or a sequence of instructions to add or otherwise reduce the elements at corresponding positions within a set of vectors. The sub-vector-based approach can be useful to simplify the mapping of non-scalable vectorised code, which may have assumed a fixed vector length, to scalable vectorised code where the sub-vector corresponds to that fixed vector length and the overall vector length is scalable according to the design choices of the hardware designer.

FIG. 14 shows an example of a sub-vector-supporting load/store instruction which can help to support the vector of vectors approach. FIG. 14 shows a contiguous load/store instruction where the block of data loaded from memory to at least one vector register or stored from at least one vector register to memory corresponds to a contiguous block of data in the memory address space. While FIG. 14 shows a load/store instruction which loads/stores a single vector register, other load/store instructions could be provided to support loads/stores of multiple vector registers. Unlike other forms of vector load/store instruction, the sub-vector-supporting vector load store treats, as the basic unit of the vector load/store operation, the sub-vector length rather than individual vector elements within the sub-vector. Hence, the predicate value Pg used to indicate which portions of the vector register are to be loaded or stored is applied at sub-vector granularity rather than at granularity of individual elements. Sub-vectors which correspond to a predicate bit of zero may be masked so that, for a load instruction, the corresponding sub-vector of the destination register Zt is not set to the value of a corresponding sub-vector loaded from memory, and for a store instruction, the data within a corresponding sub-vector of the source register Zt is not written to the corresponding addressed locations in memory.

Similarly, FIG. 15 shows a gather-scatter form of a sub-vector-supporting load/store instruction, which is capable of loading or storing, to or from a vector register Zt, a number of sub-vectors from non-contiguous blocks of addresses in memory. In this example, a vector register Zm provides an index value used to determine the block of addresses corresponding to a given sub-vector. Each index indicates a multiple of a block of data of size corresponding to the sub-vector length. Again, the predicate is applied at sub-vector granularity.

It will be appreciated that the addressing mode shown in FIGS. 14 and 15 are just one example and other examples may use a different technique to determine the addresses of the sub-vectors to be loaded to vector register or stored from vector register. For example, for other gather-scatter instructions, the vector operand used to calculate the addresses for the load/store operations for each sub-vector could be used as a vector of base addresses rather than a vector of offsets. In general, the sub-vector-supporting load/store instruction may be any load/store instruction which operates at granularity of sub-vectors.

FIG. 16 illustrates an example of a predicate setting instruction which can be used to set the predicates corresponding to a given vector at sub-vector granularity. In this example, the predicate setting instruction is a comparison instruction which sets the predicate bit Pi corresponding to sub-vector i to “true” (1) if a comparison of ‘Rn’+i with ‘Rm’ is TRUE, where ‘Rn’ is the value stored in a first scalar register Rn and ‘Rm’ is the value stored in a second scalar register Rm. Different variants of the instruction can be provided corresponding to different comparison conditions, such as LO (unsigned lower), LS (unsigned lower or same), LT (signed less than), LE (signed less than or equal), HI (unsigned higher), HS (unsigned higher or same), GT (signed greater than), or GE (signed greater than or equal). This instruction is similar to the whilelt instruction shown in the scalable code example of FIG. 4, but sets the predicates at sub-vector granularity rather than vector element granularity. This can be useful for emulating the behaviour of code which in a non-scalable vectorised example would mask out effects of an entire vector.

FIG. 17 shows a second example of sub-vector-supporting predicate setting instruction where again the predicate value is set at sub-vector granularity, but in this example the instruction specifies a certain predefined pattern which is to be applied at sub-vector granularity (e.g. the predicate bits to be set/cleared depending on the pattern to be applied are those predicate bits which correspond to the start of each sub-vector). This may differ from a corresponding predicate setting instruction which may apply the pattern at granularity of individual vector elements. For example, the predicate pattern could be to set a specified number of predict bits as active, to set as active one in every N predicates (where N is a value such as 2, 3, 4, etc.), or to set as active a number of predicate bits corresponding to the largest power of 2 which fits in predicate value when considering the implemented vector length for the hardware.

FIG. 18 illustrates an example of a sub-vector-supporting increment instruction which specifies a pattern identifier identifying a predetermined predicate pattern, and controls the processing circuitry 16 to increment a scalar operand Xdn by a number corresponding to the number of active sub-vectors indicated by the specified predicate pattern when applied at sub-vector granularity. A corresponding instruction could be provided to instead decrement the operand by the number of active sub-vectors indicated for the predicate pattern. The predicate pattern can be defined in a corresponding way to the pattern defined for the instruction of FIG. 17. This instruction can be useful for controlling incrementing or decrementing of loop count variables used to track whether it is still necessary to continue with a further loop iteration or whether it is possible to terminate the loop because all required sub-vectors have been processed.

All the instructions described above can help make it easier to adapt code written for a fixed-length vector architecture to a scalable vector architecture. It will be appreciated that not all of these instructions need be implemented in a given implementation. Also, similar sub-vector-granularity instructions could be defined for other operations.

In summary, to enable a more straightforward transition for software developers transitioning from a non-scalable, vector-length-prescribing, architecture such as Neon™ to a scalable, vector-length-agnostic, architecture such as SVE, the above examples add sub-vector (e.g. quad-word (128-bit) sized) elements and treat each sub-vector as an element in the scalable architecture. In doing so, a vector-in-vector style is formed to vectorize each fixed length vector of the non-scalable architecture using the vector length agnostic style of the scalable architecture. This allows mapping of non-scalable to scalable code with a rough 1-to-1 mapping of instructions so that vectorization can leverage longer and flexible vector length permitted in the scalable architecture and yet retain code optimizations introduced for the non-scalable architecture which rely on an assumption of a vector length known at compile time.

FIG. 19 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 330, optionally running a host operating system 320, supporting the simulator program 310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure stored in the host storage (e.g. memory or registers) of the host processor 330. In arrangements where one or more of the hardware elements referenced in the previously described embodiments are present on the host hardware (for example, host processor 330), some simulated embodiments may make use of the host hardware, where suitable.

The simulator program 310 may be stored on a computer-readable storage medium (which may be a non-transitory medium), and provides a program interface (instruction execution environment) to the target code 300 (which may include applications, operating systems and a hypervisor) which is the same as the interface of the hardware architecture being modelled by the simulator program 310. Thus, the program instructions of the target code 300 may be executed from within the instruction execution environment using the simulator program 310, so that a host computer 330 which does not actually have the hardware features of the apparatus 2 discussed above (e.g. an instruction decoder 10 and processing circuitry 16 supporting the sub-vector-supporting instructions as discussed above) can emulate these features.

Hence, the simulator program 310 may have instruction decoding program logic 312 for decoding instructions of the target code 300 and mapping these to corresponding sets of instructions in the native instruction set of the host apparatus 330. The instruction decoding program logic 312 includes sub-vector-supporting instruction decoding program logic 313 for decoding the sub-vector-supporting instructions described above. Register emulating program logic 314 maps register accesses requested by the target code to accesses to corresponding data structures maintained on the host hardware of the host apparatus 330, such as by accessing data in registers or memory of the host apparatus 330. Memory management program logic 316 implements address translation, page table walks and access permission checking to simulate access to a simulated address space by the target code 300, in a corresponding way to the MMU 36 as described in the hardware-implemented embodiment above. Memory address space simulating program logic 318 is provided to map the simulated physical addresses, obtained by the memory management program logic 316 based on address translation using the page table information maintained by software of the target program code 300, to host virtual addresses used to access host memory of the host processor 330. These host virtual addresses may themselves be translated into host physical addresses using the standard address translation mechanisms supported by the host (the translation of host virtual addresses to host physical addresses being outside the scope of what is controlled by the simulator program 310).

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to perform data processing; and
instruction decoding circuitry to control the processing circuitry to perform the data processing in response to decoding of program instructions defined according to a scalable vector instruction set architecture supporting vector instructions operating on vectors of scalable vector length to enable the same instruction sequence to be executed on apparatuses with hardware supporting different maximum vector lengths; in which:
the instruction decoding circuitry and the processing circuitry are configured to support a sub-vector-supporting instruction which treats a given vector as comprising a plurality of sub-vectors with each sub-vector comprising a plurality of vector elements, each sub-vector having an equal sub-vector length; and
in response to the sub-vector-supporting instruction, the instruction decoding circuitry is configured to control the processing circuitry to perform an operation for the given vector at sub-vector granularity.

2. The apparatus according to claim 1, in which each sub-vector has a sub-vector length which is known at compile time for a given instruction sequence to be executed using the sub-vector-supporting instruction.

3. The apparatus according to claim 1, in which how many sub-vectors are comprised by the given vector is unknown at compile time for the given instruction sequence.

4. The apparatus according to claim 1, in which in response to the sub-vector-supporting instruction, the instruction decoding circuitry is configured to control the processing circuitry to process each of the sub-vectors in response to the same instance of executing the sub-vector-supporting instruction.

5. The apparatus according to claim 1, in which each sub-vector has a sub-vector length of an architecturally-defined fixed size which is independent of a vector length used for the given vector.

6. The apparatus according to claim 5, in which the architecturally-defined fixed size corresponds to an architecturally-defined maximum vector length prescribed for vector instructions processed according to a predetermined non-scalable vector instruction set architecture.

7. The apparatus according to claim 5, in which the architecturally-defined fixed size is 128 bits.

8. The apparatus according to claim 1, in which each vector element of each sub-vector has a variable element size, and the sub-vector length is independent of which element size is used for each vector element within each sub-vector.

9. The apparatus according to claim 1, in which for at least one sub-vector-supporting instruction, the operation performed at sub-vector granularity is an operation performed, for each sub-vector, on vector elements within that sub-vector, independent of elements in other sub-vectors.

10. The apparatus according to claim 1, in which for at least one sub-vector-supporting instruction, the operation performed at sub-vector granularity is an operation performed, for each element position within a sub-vector, on respective vector elements at that element position within each of the plurality of sub-vectors.

11. The apparatus according to claim 1, in which for at least one sub-vector-supporting instruction, the operation performed at sub-vector granularity is an operation to set, or perform an operation depending on, selected predicate bits of a predicate value, where the selected predicate bits are predicate bits corresponding to sub-vector-sized portions of a vector.

12. The apparatus according to claim 1, in which, in response to a sub-vector-supporting permute instruction, the instruction decoder is configured to control the processing circuitry to set, for each sub-vector of a vector result, the sub-vector to a permutation of one or more vector elements selected from among vector elements within a correspondingly-positioned sub-vector of at least one vector operand.

13. The apparatus according to claim 1, in which, in response to a sub-vector-supporting reduction instruction, the instruction decoder is configured to control the processing circuitry to perform at least one reduction operation at sub-vector granularity, each reduction operation to reduce a plurality of vector elements of an operand vector to a single data value within a result.

14. The apparatus according to claim 13, in which, for an intra-sub-vector sub-vector-supporting reduction instruction, for each reduction operation the plurality of vector elements comprise the respective vector elements within a corresponding sub-vector of the operand vector.

15. The apparatus according to claim 13, in which, for an inter-sub-vector sub-vector-supporting reduction instruction, for each reduction operation the plurality of vector elements comprise the vector elements at corresponding element positions within a plurality of sub-vectors of the operand vector.

16. The apparatus according to claim 1, in which in response to a sub-vector-supporting load/store instruction, the instruction decoder is configured to control the processing circuitry to perform a load/store operation to transfer, at sub-vector granularity, one or more sub-vectors between a memory system and at least one vector register.

17. The apparatus according to claim 16, in which the sub-vector-supporting load/store instruction is a predicated instruction associated with a predicate value; and
in response to the sub-vector-supporting load/store instruction, the instruction decoder is configured to control the processing circuitry to control, based on predicate bits selected from the predicate value at sub-vector granularity, whether each transfer of the one or more sub-vectors is performed or masked.

18. The apparatus according to claim 1, in which in response to a sub-vector-supporting increment/decrement instruction, the instruction decoder is configured to control the processing circuitry to increment or decrement an operand value based on how many sub-vector-sized portions of a vector are indicated as active by bits of a predicate value selected from the predicate value at sub-vector granularity.

19. The apparatus according to claim 18, in which the predicate value is one of:
a predicate value specified as a predicate operand by the sub-vector-supporting increment/decrement instruction; and
a predicate value implied by a predicate pattern identifier specified by the sub-vector-supporting increment/decrement instruction, the predicate pattern identifier specifying a predetermined pattern of predicate bits at sub-vector granularity.

20. The apparatus according to claim 1, in which in response to a sub-vector-supporting predicate setting instruction, the instruction decoder is configured to control the processing circuitry to perform a predicate setting operation to set bits of a predicate value at sub-vector-granularity, to indicate which sub-vectors of a vector are active.

21. The apparatus according to claim 20, in which the predicate setting operation comprises setting the predicate value based on one of:
a predicate pattern identifier specifying a predetermined pattern of predicate bits to be applied at sub-vector granularity; and
sub-vector-granularity comparison operations based on a comparison of a first operand and a second operand.

22. A method comprising:
decoding, using instruction decoding circuitry, program instructions defined according to a scalable vector instruction set architecture supporting vector instructions operating on vectors of scalable vector length to enable the same instruction sequence to be executed on apparatuses with hardware supporting different maximum vector lengths; and
controlling processing circuitry to perform data processing in response to decoding of the program instructions; in which:
the instruction decoding circuitry and the processing circuitry support a sub-vector-supporting instruction which treats a given vector as comprising a plurality of sub-vectors with each sub-vector comprising a plurality of vector elements, each sub-vector having an equal sub-vector length; and
in response to the sub-vector-supporting instruction, the instruction decoding circuitry controls the processing circuitry to perform an operation for the given vector at sub-vector granularity.

23. A non-transitory storage medium storing a computer program to control a host data processing apparatus to provide an instruction execution environment for execution of target code; the computer program comprising:
instruction decoding program logic to decode instructions of the target code to control the host data processing apparatus to perform data processing in response to the instructions of the target code; in which:
the instruction decoding program logic supports decoding of program instructions defined according to a scalable vector instruction set architecture supporting vector instructions operating on vectors of scalable vector length to enable the same instruction sequence to be executed on apparatuses with hardware supporting different maximum vector lengths;
the instruction decoding program logic comprises sub-vector-supporting instruction decoding program logic to decode a sub-vector-supporting instruction which treats a given vector as comprising a plurality of sub-vectors with each sub-vector comprising a plurality of vector elements, each sub-vector having an equal sub-vector length; and
in response to the sub-vector-supporting instruction, the instruction decoding program logic is configured to control the host data processing apparatus to perform an operation for the given vector at sub-vector granularity.

24. (canceled)
